(19) United States
(12) Patent Application Publication
(10) Pub. No.: US 2024/0361766 A1
(43) Pub. Date: Oct. 31, 2024

(54) ROBOT CONTROL METHOD, COMPUTER-READABLE STORAGE MEDIUM AND ROBOT

(71) Applicant: SHENZHEN SILVER STAR INTELLIGENT GROUP CO., LTD., SHENZHEN (CN)

(72) Inventors: Xingwei WU, Shenzhen (CN); Juanjuan REN, Shenzhen (CN); Qi LUO, Shenzhen (CN); Lirong YE, Shenzhen (CN)

(73) Assignee: SHENZHEN SILVER STAR INTELLIGENT GROUP CO., LTD., SHENZHEN (CN)

(21) Appl. No.: 18/351,484

(22) Filed: Jul. 12, 2023

(30) Foreign Application Priority Data
Apr. 28, 2023 (CN) 202310487009.9

(51) Int. Cl. G05D 1/02; G01C 21/20

(52) U.S. Cl. CPC G05D 1/0214; G01C 21/206

(57) ABSTRACT

The present disclosure belongs to the technical field of robots, in particularly relates to a robot control method, a device, a computer-readable storage medium and a robot. The method includes selecting each candidate navigation point from a map of the robot; determining a target navigation point from each candidate navigation point according to the relative positional relationship between each candidate navigation point and the robot; and controlling the robot to move to the target navigation point. Through the above method, the best target navigation point can be determined according to the relative positional relationship between each candidate navigation point and the robot, which realizes the regular selection of the target navigation point, improves the efficiency of robot exploration and has strong practicability and ease of use.

### CROSS-REFERENCE TO RELATED APPLICATION

This application claims the priority benefit of China application serial no. 202310487009.9, filed on Apr. 28, 2023. The entirety of the above-mentioned patent application is hereby incorporated by reference herein and made a part of this specification.

### TECHNICAL FIELD

The present disclosure belongs to the technical field of robots, and in particularly relates to a robot control method, a computer-readable storage medium and a robot.

### BACKGROUND ART

With the development of science and technology, intelligent cleaning robots such as sweepers have entered thousands of households. Before helping people perform various tasks, robots move to the navigation point corresponding to the unknown region in the map to explore the unknown region, so as to build a complete map.

However, robots usually select navigation points randomly, resulting in low exploration efficiency.

### BRIEF DESCRIPTION OF DRAWINGS

In order to more clearly illustrate the technical solutions in the embodiments of the present disclosure, the accompanying drawings that need to be used in the embodiments or the descriptions of the prior art will be briefly introduced below. Obviously, the accompanying drawings described in the following are only for some embodiments of the present disclosure, those ordinarily skilled in the art can also obtain other drawings based on these drawings without inventive efforts.

FIG. 1 is a flowchart of the embodiment of the robot control method in the embodiment of the present disclosure;

FIG. 2 is a schematic view of a home environment;

FIG. 3 is the schematic view with the gap region removed;

FIG. 4 is the schematic view of selecting candidate navigation point;

FIG. 5 is the schematic flowchart of the selection process for the candidate navigation point;

FIG. 6 is a schematic view of the generation process for the boundary line;

FIG. 7 is a schematic view of noise points;

FIG. 8 is a schematic flowchart of the determination process for the target navigation point;

FIG. 9 is a schematic view of long-side obstacles;

FIG. 10 is a schematic view of a connecting line between candidate navigation points and the robot;

FIG. 11 is a schematic view of correcting the target navigation point;

FIG. 12 is a structural view of an embodiment of the robot control device in the embodiment of the present disclosure;

FIG. 13 is a schematic block diagram of a robot in the embodiment of the present disclosure.

### DETAILED DESCRIPTION OF EMBODIMENTS

In order to make the purpose, features and advantages of the present disclosure more obvious and understandable, the technical solutions in the embodiments of the present disclosure will be clearly and completely described below in conjunction with the drawings of the embodiments of the present disclosure. Obviously, the following described embodiments are only some of the embodiments of the present disclosure, rather all of them. Based on the embodiments in the present disclosure, all other embodiments obtained by persons of ordinary skill in the art without making inventive efforts belong to the scope of protection of the present disclosure.

It should be understood that when being used in the specification and the claims appended, the term “comprise” indicates the presence of described features, integers, steps, operations, elements and/or components, but does not exclude the presence or addition of one or more other features, integers, steps, operations, elements, components and/or collections thereof.

It should also be understood that the terminology used in the specification of the present disclosure is merely for the purpose of describing specific embodiments and is not intended to limit the present disclosure. As showed in this specification and the claims appended, the singular forms “a/an”, “one” and “the” are intended to include plural referents unless the context clearly dictates otherwise.

It should also be further understood that the term “and/or” used in the description of the present disclosure and the claims appended refers to any combination of one or more of the associated listed items and all possible combinations, and these combinations are included.

As used in this specification and the appended claims, the term “if” can be construed as “when” or “once” or “in response to determining” or “in response to detecting” depending on the context. Similarly, the phrases “if yes” or “if [the described condition or event] is detected” can be construed, depending on the context, as “once determined” or “in response to the determination” or “once [the described condition or event] is detected” or “in response to detection of [described condition or event]”.

In addition, in the description of the present disclosure, terms such as “first”, “second”, and “third” are only used to distinguish descriptions, and cannot be understood as indicating or implying relative importance.

With the development of science and technology, intelligent cleaning robots such as sweepers have entered households. Before helping people perform various tasks, the robot will move to the navigation point corresponding to the unknown region in the map to explore the unknown region, thereby building a complete map.

However, robots usually select navigation points randomly, resulting in low exploration efficiency.

In view of this, embodiments of the present disclosure provide a robot control method, a device, a computer-readable storage medium, and a robot to solve the problem that the robot selects navigation points randomly in unknown regions during the exploration process, resulting in low exploration efficiency. Through the embodiment of the present disclosure, the best target navigation point can be determined according to the relative positional relationship between each candidate navigation point and the robot, which realizes the regular selection of the target navigation point, thereby improving the efficiency of robot exploration, and resulting in a strong practicality and ease of use.

It should be noted that the execution subject of the method of the present disclosure can be a robot, including but not limited to sweepers, mopping machines, inspection robots, guiding robots, food delivery robots and other common service robots in the prior art.

In the embodiments of the present disclosure, the robot can perform preliminary map construction to obtain an initial map, in which multiple different regions can be included in the initial map, which can be classified as known regions, obstacles, and unknown regions according to the specific exploration conditions for different regions. Unknown regions in the initial map can be explored to build a more complete map before the robot performs a task.

Specifically, the robot can utilize a variety of pre-installed sensors to explore the map, including but not limited to lidar, vision sensors, infrared sensors, positioning sensors and other common sensors installed on the robot.

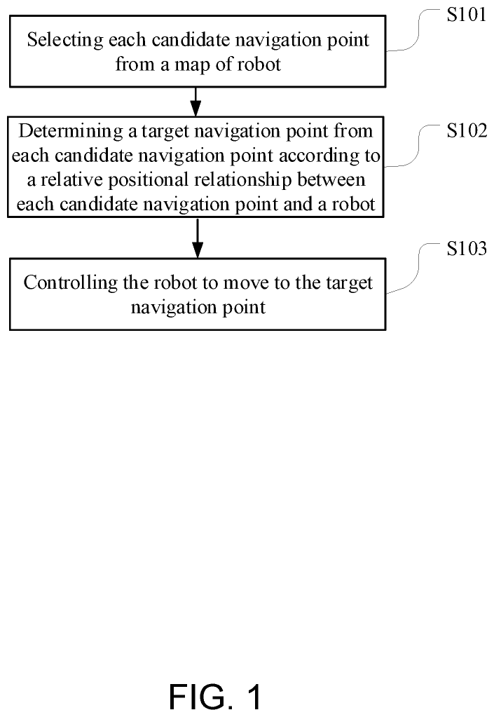

Referring to FIG. 1, an embodiment of a robot control method in the embodiments of the present disclosure can include the following steps.

Step S101, selecting each candidate navigation point from the map of the robot.

In the embodiment of the present disclosure, each candidate navigation point can be selected from the initial map of the robot, wherein the candidate navigation points are navigation points in an unknown region, and each navigation point in an unknown region can be selected as a candidate navigation point herein.

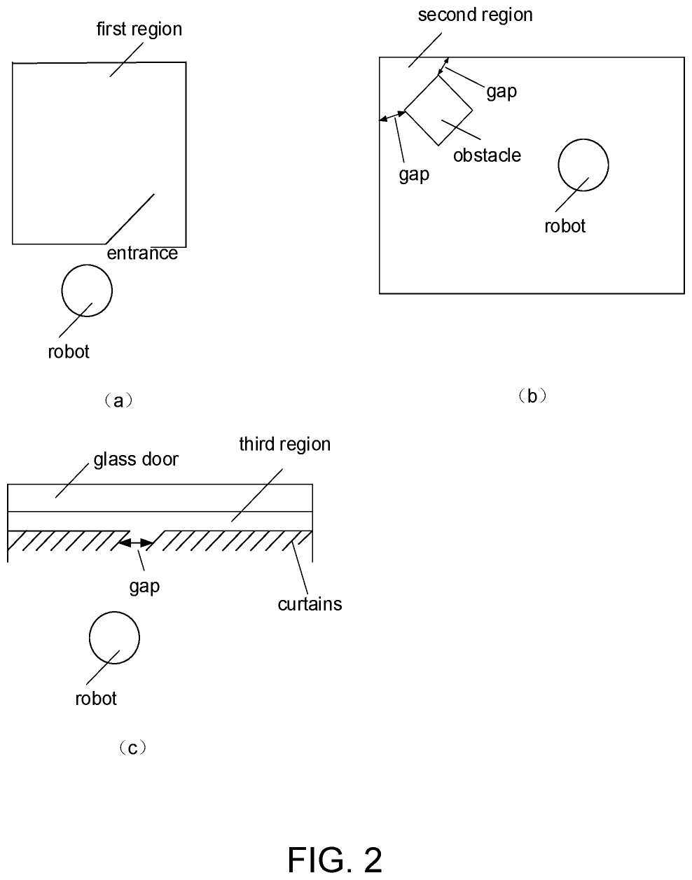

It is understandable that in the actual home environment, many gaps can exist, as shown in (a) of FIG. 2, the robot cannot enter the first region whose entrance width is smaller than the width of robot itself, or as shown in (b) of FIG. 2, the robot cannot enter the second region behind the obstacle, or as shown in (c) of FIG. 2, the curtains cover the glass door, wherein a gap is formed between the curtains, through which the robot cannot enter the third region.

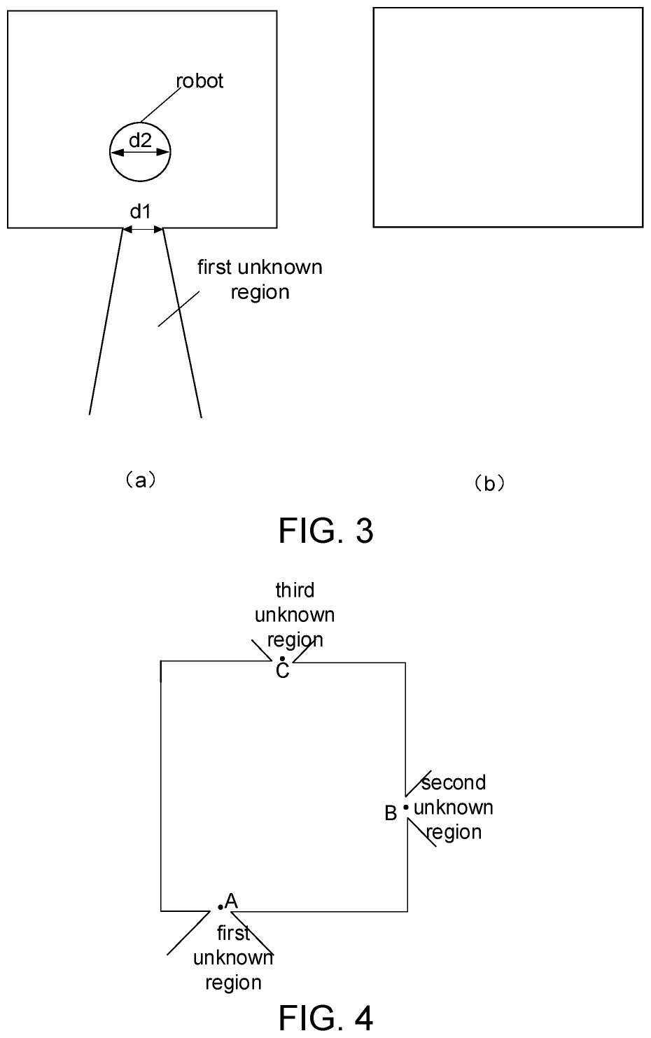

Therefore, in the embodiment of the present disclosure, before selecting candidate navigation points, gap regions can be eliminated to improve the efficiency of map exploration. Specifically, the robot can identify the gap region, from the map, whose entrance width is smaller than the preset width threshold, referring to (a) of FIG. 3. When the entrance width d1 of the first unknown region is less than the width threshold (here it can be robot diameter d2), the first region can be identified as a gap region. At this time, even if the robot navigates to the entrance of the first unknown region, it cannot enter the first unknown region through the entrance of the first unknown region for exploration. Therefore, the first unknown region can be removed from the map, so as to avoid the exploration of first unknown region performed by the robot, and the map shown in (b) of FIG. 3 is obtained, wherein the width threshold can be set to a value greater than or equal to the width of the robot itself according to actual needs.

It can be understood that each unknown region can have a corresponding navigation point, and when the robot moves to the corresponding navigation point of the unknown region, it can utilize the preset sensors to explore the unknown region. For example, referring to FIG. 4, the initial map can include three unknown regions, namely the first unknown region, the second unknown region and the third unknown region, wherein the corresponding navigation points are navigation points A, B and C, respectively. After the robot moves to the navigation point corresponding to the unknown region, the unknown region can be explored at the corresponding navigation point. Navigation points A, B and C can be selected as candidate navigation points herein.

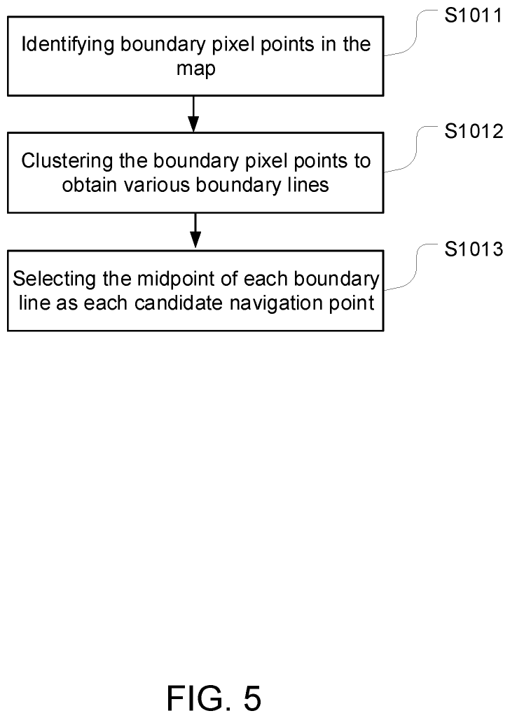

Referring to FIG. 5, the selection of candidate navigation points in step S101 can specifically include the following processes.

Step S1011, identifying boundary pixel points in the map.

In the embodiment of the present disclosure, boundary pixel points can be identified in the initial map, wherein the boundary pixel points are known region pixel points adjacent to unknown region pixel points.

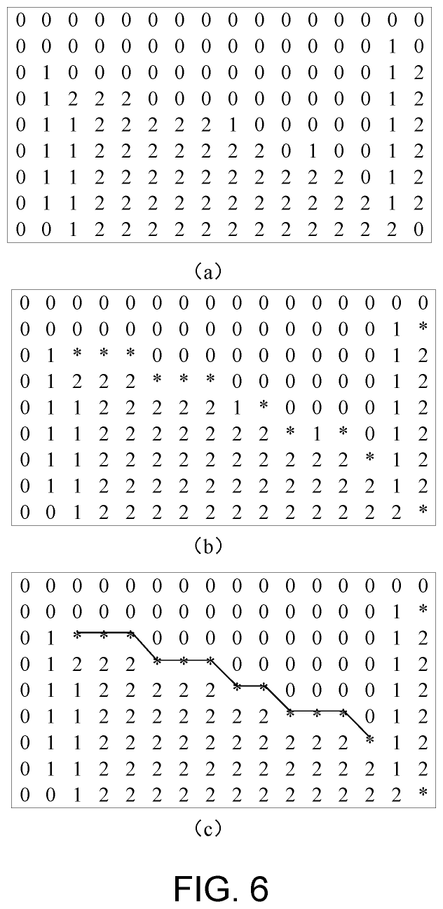

Specifically, according to the specific classification of the region (known region, obstacle, and unknown region), the pixel points corresponding to the region in the initial map can be marked. Referring to (a) of FIG. 6, if the region is a known region, the pixel point in the initial map corresponding to the region herein can be marked as 0 (denoted as pixel point 0); if the region is an obstacle, the pixel point in the initial map corresponding to the region herein can be marked as 1 (denoted as pixel point 1); and if the region is an unknown region, the pixel point in the initial map corresponding to the region herein can be marked as 2 (denoted as pixel point 2).

Afterwards, pixel points of known region adjacent to unknown regions in the initial map can be identified. Referring to (b) of FIG. 6, the pixel points 0 adjacent to the pixel points 2 can be identified, such that the boundary pixel points are obtained (for the convenience of display, the boundary pixel points are marked as * in the figure).

Step S1012, clustering the boundary pixel points to obtain various boundary lines.

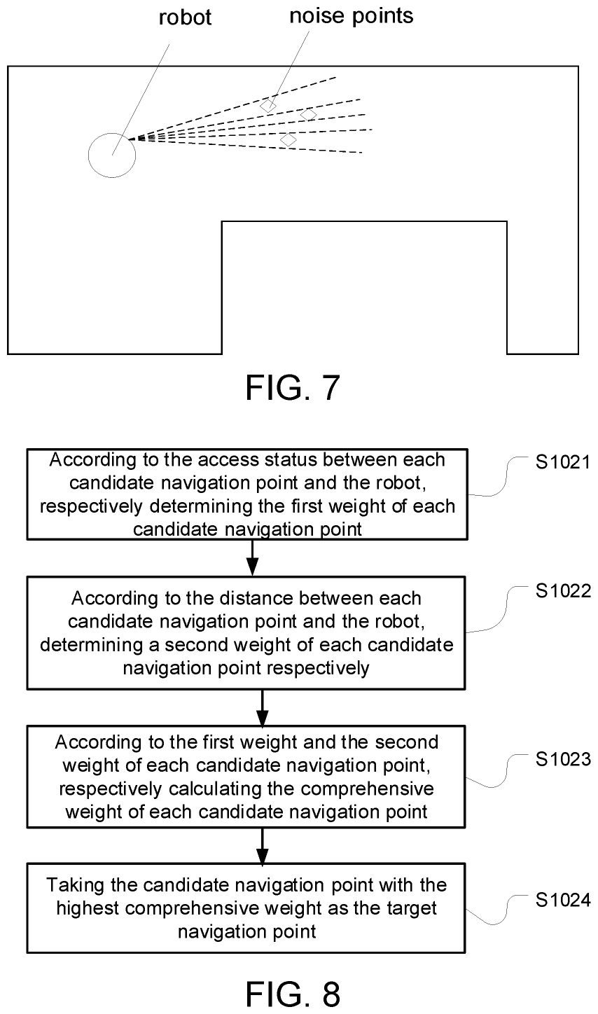

It is understandable that, referring to FIG. 7, when the robot detects in the actual home environment via sensors, environmental factors such as walking people, reflection from mirrors, or other strong lights may cause noise points on the initial map generated. If the noise points are considered as an obstacle at the boundary of the unknown region, they tend to affect the unknown region exploration by the robot. Since the noise points are usually scattered, image filtering can be used to filter the scattered noise points in the map to achieve noise reduction on the initial map.

Specifically, in the embodiment of the present disclosure, the boundary pixel points can be clustered, wherein the boundary pixel points whose distance is less than the preset distance threshold are connected. If a pixel point 1 (obstacle) exists between any two connected boundary pixel points, then the obstacle can be considered as an interference noise point, and the pixel point 1 should actually be a passable region. The pixel point 1 is also identified as the boundary pixel point, so as to obtain each boundary line.

Referring to (c) of FIG. 6, the boundary pixel points whose distance is less than the distance threshold can be connected, and the pixel point 1 existing between any two connected boundary pixel points can also be used as the boundary pixel point to obtain the boundary line. The pixel points on the boundary line are all considered to be passable known regions. The distance threshold can be set concretely and contextually according to actual needs, which is not specifically limited in the embodiment of the present disclosure.

Step S1013, selecting the midpoint of each boundary line as each candidate navigation point.

In the embodiment of the present disclosure, the midpoint of each boundary line can be selected as each candidate navigation point. When the robot moves to the candidate navigation point corresponding to the unknown region, the unknown region can be explored.

It is understandable that the robot can move to any point on the boundary line to explore the unknown region. Therefore, in addition to taking the midpoint of the boundary line as a candidate navigation point, any point on the boundary line can also be used as candidate navigation point.

Step S102, determining a target navigation point from each candidate navigation point according to the relative positional relationship between each candidate navigation point and the robot.

In the above, the relative positional relationship in the embodiment of the present disclosure can include the access status and the distance, that is, according to the access state between each candidate navigation point and the robot and the distance between each candidate navigation point and the robot, the target navigation point can be determined from each candidate navigation point.

Referring to FIG. 8, Step S102 can specifically include the following processes.

Step S1021, according to the access status between each candidate navigation point and the robot, respectively determining the first weight of each candidate navigation point.

In the embodiment of the present disclosure, the access status between each candidate navigation point and the robot can be respectively determined, and the first weight of each candidate navigation point can be determined according to the access status between each candidate navigation point and the robot.

It is understandable that if the exploration path between the candidate navigation point and the robot includes bypassing long-side obstacles such as walls, it may lead to a longer exploration distance and reduce the efficiency of exploration. At this time, the access status between the candidate navigation point and the robot can be set as blocked status. If the exploration path between the candidate navigation point and the robot does not include bypassing long-side obstacles such as walls, the access status between the candidate navigation point and the robot can be set as the directly communicated status.

In the embodiment of the present disclosure, compared with the candidate navigation points that are in the blocked status related to the robot, the candidate navigation points that are in the directly communicated status related to the robot can be assigned with a higher first weight to perform priority exploration, wherein the value of the first weight can be set concretely and contextually according to actual needs, which is not specifically limited in the embodiment of the present disclosure.

For the convenience of description, the following will take any one of the candidate navigation points (denoted as the current candidate navigation point) as an example to describe the process of determining the access status in the embodiment of the present disclosure.

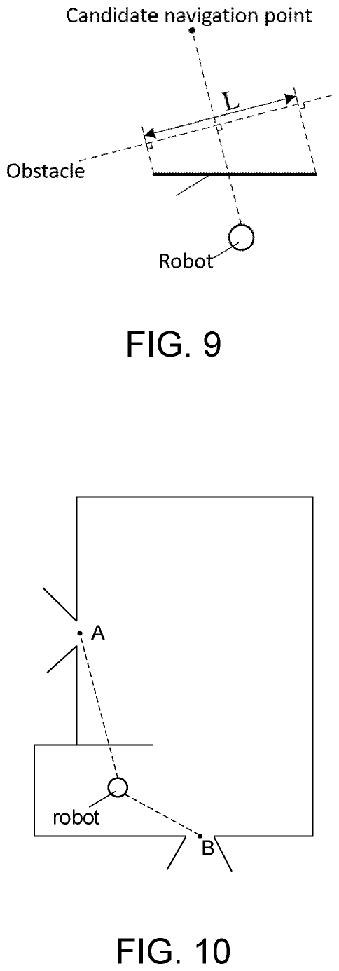

It should be understood that when the robot detects via the preset sensors, long-side obstacles such as walls can be identified. The long-side obstacle is an obstacle whose projected length on the vertical line of the connecting line between the candidate navigation point and the robot is greater than the preset length threshold, wherein the value of the length threshold can be set specifically and contextually according to actual needs, which is not limited in the embodiment of the present disclosure. Referring to FIG. 9, since the projected length L of the obstacle on the vertical line of the connecting line between the candidate navigation point and the robot is greater than the preset length threshold, the obstacle can be identified as a long-side obstacle.

Specifically, in the embodiment of the present disclosure, the connecting line between the current candidate navigation point and the robot can be constructed, and then whether the connecting line passes through the long-side obstacle in the map can be determined; if the connecting line passes through the long-side obstacle in the map, it can be determined that the current candidate navigation point and the robot are in a blocked status; and if the connecting line does not pass through the long-side obstacle in the map, it can be determined that the current candidate navigation point and the robot are in directly communicated status. As shown in FIG. 10, if the candidate navigation point A is selected as the current candidate navigation point, at this time, the connecting line between point A and the robot passes through the long-side obstacle in the map, it can be considered that the robot may need to bypass the long-side obstacle to navigate to point A, and therefore, the access status between point A and the robot can be set as a blocked status; and if the candidate navigation point B is selected as the current candidate navigation point, at this time, the connecting line between point B and the robot does not pass through the long-side obstacles in the map, it can be considered that the robot does not need to move around the long-side obstacles when navigating to point B, and therefore, the access status between point B and the robot can be set as a directly communicated status.

It can be understood that the preset sensor can be used to determine whether the connecting line between the current candidate navigation point and the robot passes through the long-side obstacle in the map. For example, the lidar sensor of the robot can scan toward the direction of the connecting line between the current candidate navigation point and the robot, so as to detect whether there is an obstacle. If the current candidate navigation point cannot be reached when the lidar scans toward the direction of the connecting line, it can be considered that the connecting line passes through the obstacles in the map; and if the current candidate navigation point can be reached when the lidar scans toward the direction of the connecting line, it can be considered that the connecting line does not pass through the obstacles in the map. If the connecting line passes through the obstacle in the map, the lidar can be controlled to scan towards both sides of the obstacle to determine the length of the obstacle. After that, whether the obstacle is a long-side obstacle or not can be determined according to the relationship between the length of the obstacle and the length threshold.

It can be understood that, by traversing each candidate navigation point and performing the above operations, the access status between each candidate navigation point and the robot can be determined, and the first weight is determined according to the access status.

Step S1022, according to the distance between each candidate navigation point and the robot, respectively determining a second weight of each candidate navigation point.

It is understandable that, compared with unknown regions that are farther away, the unknown regions that are closer can be explored first, so as to improve the efficiency of robot exploration.

Therefore, in the embodiment of the present disclosure, a higher second weight can be assigned to a candidate navigation point that is closer to the robot, and a lower second weight can be assigned to a candidate navigation point that is farther from the robot. For example, each candidate navigation point can be sorted in ascending order according to the distance from the robot, and according to the sorting order, each candidate navigation point is assigned a second weight from high to low.

The value of the second weight can be set concretely and contextually according to actual needs, which is not specifically limited in the embodiment of the present disclosure.

Step S1023, according to the first weight and the second weight of each candidate navigation point, calculating the comprehensive weight of each candidate navigation point respectively.

In the embodiment of the present disclosure, the comprehensive weight of each candidate navigation point can be determined based on overall consideration of the access status and distance between each candidate navigation point and the robot.

In a possible embodiment, the first weight and the second weight of each candidate navigation point can be added to obtain a comprehensive weight of each candidate navigation point.

In another possible embodiment, a weighted average of the first weight and the second weight of each candidate navigation point can be calculated to obtain the comprehensive weight of each candidate navigation point.

Step S1024, determining the candidate navigation point with the highest comprehensive weight as the target navigation point.

In the embodiment of the present disclosure, the candidate navigation point with the highest comprehensive weight can be considered as the best candidate navigation point at present, and therefore, the candidate navigation point with the highest comprehensive weight can be determined as the target navigation point, such that the robot moves to the target navigation point to perform exploration for unknown regions.

Step S103, controlling the robot to move to the target navigation point.

In the embodiment of the present disclosure, any path planning algorithm in the prior art can be used to plan the exploration path between the robot and the target navigation point, and the robot is controlled to move to the target navigation point according to the exploration path. The specific path planning algorithms can include but are not limited to Best-First Searching (BFS), Depth-First Searching (DFS), Dijkstra's algorithm (Dijkstra's), Rapidly-exploring Random Trees (RRT) and any common path planning algorithm in the prior art.

It can be understood that a sensor used for map exploration has a certain detection range. Generally, regions within the detection range of the sensor can be explored through the sensor. For example, the lidar sensor can be used for map exploration, and its detection range is a circle with the detection distance as the radius. When the unknown region to be explored is within the detection range, the unknown region can be explored. Therefore, in order to reduce the exploration time and improve the exploration efficiency, the target navigation point can be modified to obtain the corrected target navigation point, so as to reduce the distance of the exploration path and control the robot to move to the corrected target navigation point to explore the unknown region.

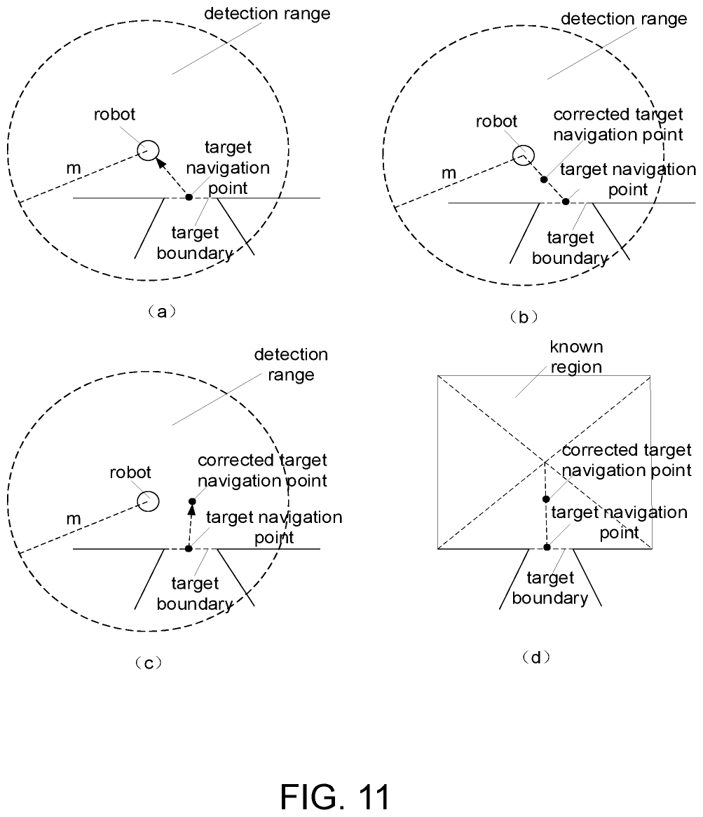

Specifically, the target navigation point can be moved in a direction away from the target boundary to obtain a corrected target point, wherein the target boundary is an unknown region boundary corresponding to the target navigation point. For example, referring to (a) of FIG. 11, the detection range of the sensor is a circle with the detection distance m as the radius, and the unknown region is within the detection range of the sensor, at this time, the target navigation point can be moved by a preset moving distance in the direction away from the target boundary on the exploration path to get the corrected target navigation point as shown in (b) of FIG. 11. For another example, the target navigation point can be moved by a preset moving distance in any direction away from the target boundary to obtain the corrected target navigation point as shown in (c) of FIG. 11. For another example, the target navigation point can be moved by a preset moving distance toward the center of the geometric shape of the map to obtain the corrected target navigation point as shown in (d) of FIG. 11. The value of the moving distance can be set concretely and contextually according to the detection range and the length of the exploration path, which is not specifically limited in the embodiment of the present disclosure.

It can be understood that after obtaining the corrected target navigation point, the robot can be controlled to move to the corrected target navigation point to explore the unknown region. After that, the target navigation point can be re-determined by referring to the above-mentioned method to explore the unknown region until a complete map is constructed.

In summary, in the embodiment of the present disclosure, each candidate navigation point is selected from the map of the robot; the target navigation point is determined from each candidate navigation point according to the relative positional relationship between each candidate navigation point and the robot; and the robot is controlled to move to the target navigation point. Through the embodiment of the present disclosure, the best target navigation point can be determined according to the relative positional relationship between each candidate navigation point and the robot, which realizes the regular selection for the target navigation point, improves the efficiency of robot exploration and has a strong practicality and ease of use.

It should be understood that the sequence numbers of the steps in the above embodiments do not mean the order of execution, and the execution order of each process should be determined by its function and internal logic, which should not constitute any limitation to the implementation process of the embodiment of the present disclosure.

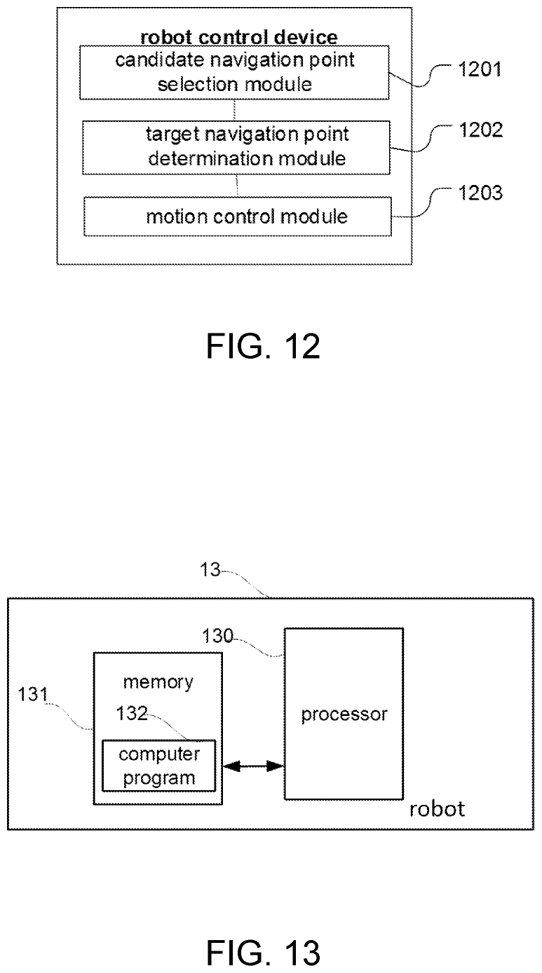

Corresponding to a robot control method described in the above embodiments, FIG. 12 shows a structural view of an embodiment of a robot control device provided in an embodiment of the present disclosure.

In this embodiment, a robot control device can include:
a candidate navigation point selection module 1201, configured to select each candidate navigation point from the map of the robot;
a target navigation point determination module 1202, configured to determine a target navigation point from each candidate navigation point according to the relative positional relationship between each candidate navigation point and the robot; and
a motion control module 1203, configured to control the robot to move to the target navigation point.

In a specific implementation manner of the embodiment of the present disclosure, the relative positional relationship can include an access status and a distance.

The target navigation point determination module can include:
an access status determination unit, configured to respectively determine the access status between each candidate navigation point and the robot;
a distance calculation unit, configured to respectively calculate the distance between each candidate navigation point and the robot; and
a target navigation point determination unit, configured to determine the target navigation point from each candidate navigation point according to the access status and distance between each candidate navigation point and the robot.

In a specific implementation manner of the embodiment of the present disclosure, the access status determination unit can include:
a line construction subunit, configured to construct a connecting line between the current candidate navigation point and the robot, wherein the current candidate navigation point is any candidate navigation point;
a determining subunit, configured to determine whether the connecting line passes through the long-side obstacle in the map;
a blocked status determination subunit, configured to determine that the current candidate navigation point and the robot are in a blocked state, when the connecting line passes through a long-side obstacle in the map; and
a directly communicated status determination subunit, configured to determine that the current candidate navigation point and the robot are in a directly communicated status, when the connecting line does not pass through the long-side obstacle in the map.

In a specific implementation manner of the embodiment of the present disclosure, the target navigation point determination unit can include:
a first weight determination subunit, configured to respectively determine the first weight of each candidate navigation point according to the access status between each candidate navigation point and the robot;
a second weight determination subunit, configured to respectively determine the second weight of each candidate navigation point according to the distance between each candidate navigation point and the robot;
a comprehensive weight calculation subunit, configured to respectively calculate the comprehensive weight of each candidate navigation point according to the first weight and the second weight of each candidate navigation point; and
a target navigation point determination subunit, configured to determine the candidate navigation point with the highest comprehensive weight as the target navigation point.

In a specific implementation manner of the embodiment of the present disclosure, the motion control module can include:
a navigation point correction unit, configured to move the target navigation point in the direction away from the target boundary to obtain a corrected target navigation point, wherein the target boundary is an unknown region boundary corresponding to the target navigation point; and
a motion control unit, configured to control the robot to move to the corrected target navigation point.

In a specific implementation of the embodiment of the present disclosure, the candidate navigation point selection module can include:
a boundary pixel point identification unit, configured to identify boundary pixel points in the map, wherein the boundary pixel points are known region pixel points adjacent to unknown region pixel points;
a pixel point clustering unit, configured to cluster the boundary pixel points to obtain each boundary line; and
a candidate navigation point selection unit, configured to select the midpoints of each boundary line as each candidate navigation point.

In a specific implementation manner of the embodiment of the present disclosure, the robot control device can further include:
a gap identification module, configured to identify a gap region in the map, wherein the gap region is a region whose entrance width is smaller than a preset width threshold; and
a gap elimination module, configured to remove the gap region from the map.

Those skilled in the art can clearly understand that for the convenience and brevity of the description, the specific working process of the above-described devices, modules and units can refer to the corresponding process in the foregoing method embodiments, which will not be repeated here.

In the above-mentioned embodiments, the descriptions of each embodiment have their own emphases, and for parts that are not detailed or recorded in a certain embodiment, the relevant descriptions of other embodiments can be referred to.

FIG. 13 shows a schematic block diagram of a robot provided by the embodiment of the present disclosure. For convenience of description, only parts related to the embodiment of the present disclosure are shown.

As shown in FIG. 13, the robot 13 of this embodiment includes: a processor 130, a memory 131 and a computer program 132 stored in the memory 131 and executable on the processor 130. When the processor 130 executes the computer program 132, the steps in the above embodiments of the robot control method are realized, such as the steps S101 to S103 shown in FIG. 1. Alternatively, the functions of the modules/units in the above-mentioned device embodiments are realized when the processor 130 executes the computer program 132, such as the functions of the modules 1201 to 1203 shown in FIG. 12.

Exemplarily, the computer program 132 can be divided into one or more modules/units, wherein the one or more modules/units are stored in the memory 131 and executed by the processor 130 to complete the present disclosure. The one or more modules/units can be a series of computer program instruction segments capable of accomplishing specific functions, wherein the instruction segments are used to describe the execution process of the computer program 132 in the robot 13.

Those skilled in the art can understand what is shown in FIG. 13 is only an example of the robot 13, which does not constitute a limitation to the robot 13. More or less components than shown in the illustration can be included or certain components or different components can be combined, for example, the robot 13 can also include input and output devices, network access devices, buses and the like.

The processor 130 can be Central Processing Unit (CPU), other general-purpose processors, Digital Signal Processor (DSP), Application Specific Integrated Circuit (ASIC), Field-Programmable Gate Array (FPGA) or other programmable logic devices, discrete gate or transistor logic devices, discrete hardware components, etc. A general-purpose processor can be a microprocessor, while the processor can be any conventional processor or the like.

The memory 131 can be an internal storage unit of the robot 13, such as a hard disk or memory of the robot 13. The memory 131 can also be an external storage device of the robot 13, such as plug-in hard disk, Smart Media Card (SMC), Secure Digital (SD) card, Flash Card, etc. equipped on the robot 13. Further, the memory 131 can also include both an internal storage unit of the robot 13 and an external storage device. The memory 131 is used to store the computer program and other programs and data required by the robot 13. The memory 131 can also be used to temporarily store data that has been output or will be output.

Those skilled in the art can clearly understand that for the convenience and brevity of description, the division of the above-mentioned functional units and modules is only used for exemplary illustration. In practical application, the above-mentioned functions can be assigned to different functional units/modules to accomplish according to needs, that is, the internal structure of the device is divided into different functional units or modules to complete all or part of the functions described above. Each functional unit and module in the embodiment can be integrated into one processing unit, or each unit may exist separately physically, or two or more units can be integrated into one unit, wherein the above-mentioned integrated units can be implemented in the form of hardware or can be implemented in the form of software function units as well. In addition, the specific names of the functional units and modules are only for the convenience of distinguishing each other, and are not used to limit the protection scope of the present disclosure. For the specific working process of the units/modules in the above system, reference can be made to the corresponding process in the foregoing method embodiments, and details will not be repeated here.

In the above-mentioned embodiments, the descriptions of each embodiment have their own emphases, and for parts that are not detailed or recorded in a certain embodiment, the relevant descriptions of other embodiments can be referred to.

Those skilled in the art can appreciate that the units and steps of algorithm in the examples described in conjunction with the embodiments disclosed herein can be implemented by electronic hardware or a combination of computer software and electronic hardware. Whether these functions are executed by hardware or software depends on the specific application and design constraints of the technical solution. Those skilled in the art can use different methods to implement the described functions for each specific application, but such implementation should not be regarded as exceeding the scope of the present disclosure.

In the embodiments provided in the present disclosure, it should be understood that the disclosed devices/robots and methods can be implemented in other ways. For example, the device/robot embodiments described above are only illustrative, such as the division of the modules or units is only a logical function division. In practical implementation, other division methods can be applied, such as multiple units or components can be combined or integrated into another system, or some features can be omitted or cannot implemented. In another point, the mutual coupling or direct coupling or communication connection shown or discussed can be the indirect coupling or communication connection through some interfaces, devices or units, which can be electrical, mechanical or in other forms.

The units described as separate components can or cannot be physically separated, and the components shown as units can or cannot be physical units, that is, they can be located in one place, or can be distributed to multiple network units. Part or all of the units can be selected according to actual needs to achieve the purpose of the solution of the present embodiment.

In addition, each functional unit in each embodiment of the present disclosure can be integrated into one processing unit, or each unit can exist separately physically, or two or more units can be integrated into one unit. The above-mentioned integrated units can be implemented in the form of hardware or in the form of software function units.

If the integrated module/unit is realized in the form of a software function unit and sold or used as an independent product, it can be stored in a computer-readable storage medium. Based on this understanding, all or part of the processes in the methods of the above embodiments in the present disclosure can also be completed by instructing related hardware through computer programs. The computer programs can be stored in a computer-readable storage medium, when the computer program is executed by the processor, the steps in the above-mentioned various method embodiments can be realized. The computer program includes computer program code, wherein the computer program code can be in the form of source code, object code, executable file or some intermediate form, etc. The computer-readable storage medium can include: any substance or device capable of carrying the computer program code, recording medium, USB flash drive, removable hard disk, magnetic disk, optical disk, computer memory, a Read-Only Memory (ROM), Random Access Memory (RAM), electric carrier signal, telecommunication signal and software distribution medium, etc. It should be noted that the content contained in the computer-readable storage medium can be appropriately added or removed according to the requirements of legislation and patent practice in the jurisdiction. For example, in some jurisdictions, according to legislation and patent practice, computer-readable storage media excludes electrical carrier signals and telecommunication signals.

The above-described embodiments are only used to illustrate the technical solutions of the present disclosure, rather than to limit them; although the present disclosure has been described in detail with reference to the foregoing embodiments, those of ordinary skill in the art should understand that the technical solutions described in the foregoing embodiments can still be modified or equivalent replacements can be performed on some of the technical features, while these modifications or replacements do not make the essence of the corresponding technical solutions deviate from the spirit and scope of the technical solutions of the various embodiments of the present disclosure, which should be included within the protection scope of the present disclosure.

What is claimed is:

1. A robot control method, comprising:
selecting, by at least one processer, each candidate navigation point from a map of a robot;
determining, by at least one processer, a target navigation point from each candidate navigation point according to a relative positional relationship between each candidate navigation point and the robot; and
controlling, by at least one processer, the robot to move to the target navigation point.

2. The robot control method according to claim 1, wherein the relative positional relationship comprises an access status and a distance; and
the determining a target navigation point from each candidate navigation point according to a relative positional relationship between each candidate navigation point and the robot comprises:
determining, by the at least one processer, the access status between each candidate navigation point and the robot, respectively;
calculating, by the at least one processer, the distance between each candidate navigation point and the robot, respectively; and
determining, by the at least one processer, the target navigation point from each candidate navigation point according to the access status and the distance between each candidate navigation point and the robot.

3. The robot control method according to claim 2, wherein the determining the access status between each candidate navigation point and the robot, respectively comprises:
constructing, by the at least one processer, a connecting line between a current candidate navigation point and the robot, wherein the current candidate navigation point is any candidate navigation point;
determining, by the at least one processer, whether the connecting line passes through a long-side obstacle in the map;
when the connecting line passes through the long-side obstacle in the map, determining that the current candidate navigation point and the robot are in a blocked status; and
when the connecting line does not pass through the long-side obstacle in the map, determining that the current candidate navigation point and the robot are in a directly communicated status.

4. The robot control method according to claim 2, wherein the determining the target navigation point from each candidate navigation point according to the access status and the distance between each candidate navigation point and the robot comprises:
determining, by the at least one processer, a first weight of each candidate navigation point respectively according to the access status between each candidate navigation point and the robot;
determining, by the at least one processer, a second weight of each candidate navigation point respectively according to the distance between each candidate navigation point and the robot;
calculating, by the at least one processer, a comprehensive weight of each candidate navigation point respectively according to the first weight and the second weight of each candidate navigation point; and
determining, by the at least one processer, a candidate navigation point with a highest comprehensive weight as the target navigation point.

5. The robot control method according to claim 1, wherein the controlling the robot to move to the target navigation point comprises:
moving, by the at least one processer, the target navigation point in a direction away from a target boundary to obtain a corrected target navigation point, wherein the target boundary is an unknown region boundary corresponding to the target navigation point; and
controlling, by at least one processer, the robot to move to the corrected target navigation point.

6. The robot control method according to claim 1, wherein the selecting each candidate navigation point from a map of a robot comprises:
identifying, by the at least one processer, boundary pixel points in the map, wherein the boundary pixel points are known region pixel points adjacent to unknown region pixel points;
clustering, by the at least one processer, the boundary pixel points to obtain each boundary line; and
selecting, by the at least one processer, a midpoint of each boundary line as each candidate navigation point.

7. The robot control method according to claim 1, wherein, before the selecting each candidate navigation point from a map of a robot, the robot control method further comprises:
identifying, by the at least one processer, a gap region in the map, wherein the gap region is a region whose entrance width is smaller than a preset width threshold; and
removing, by the at least one processer, the gap region from the map.

8. A computer-readable storage medium, wherein the computer-readable storage medium stores a computer program, wherein steps of the robot control method according to claim 1 is realized, when the computer program is executed by a processor.

9. A robot, comprising a memory, a processor and a computer program stored in the memory and operable on the processor, wherein steps of the robot control method according to claim 1 is realized, when the processor executes the computer program.

10. The robot control method according to claim 2, wherein, before the selecting each candidate navigation point from a map of a robot, the robot control method further comprises:
identifying a gap region in the map, wherein the gap region is a region whose entrance width is smaller than a preset width threshold; and
removing the gap region from the map.

11. The robot control method according to claim 3, wherein, before the selecting each candidate navigation point from a map of a robot, the robot control method further comprises:
identifying a gap region in the map, wherein the gap region is a region whose entrance width is smaller than a preset width threshold; and
removing the gap region from the map.

12. The robot control method according to claim 4, wherein, before the selecting each candidate navigation point from a map of a robot, the robot control method further comprises:
identifying a gap region in the map, wherein the gap region is a region whose entrance width is smaller than a preset width threshold; and
removing the gap region from the map.

13. The robot control method according to claim 5, wherein, before the selecting each candidate navigation point from a map of a robot, the robot control method further comprises:
identifying a gap region in the map, wherein the gap region is a region whose entrance width is smaller than a preset width threshold; and
removing the gap region from the map.

14. The robot control method according to claim 6, wherein, before the selecting each candidate navigation point from a map of a robot, the robot control method further comprises:
identifying a gap region in the map, wherein the gap region is a region whose entrance width is smaller than a preset width threshold; and
removing the gap region from the map.

15. The robot control method according to claim 3, wherein the long-side obstacle is an obstacle whose projected length on a vertical line of the connecting line between the candidate navigation point and the robot is greater than a preset length threshold, wherein the long-side obstacle comprises walls.

16. The robot control method according to claim 3, wherein the access status comprises the blocked status and the directly communicated status.

17. The robot control method according to claim 4, wherein when an exploration path between the candidate navigation point and the robot comprises bypassing long-side obstacles, the access status between the candidate navigation point and the robot is set as the blocked status; and when an exploration path between the candidate navigation point and the robot does not comprise the bypassing long-side obstacles, the access status between the candidate navigation point and the robot is set as the directly communicated status, wherein compared with the candidate navigation point that is in the blocked status related to the robot, the candidate navigation point that is in the directly communicated status related to the robot is assigned with a higher first weight to perform priority exploration.

18. The robot control method according to claim 4, wherein a higher second weight is assigned to a candidate navigation point that is closer to the robot, and a lower second weight is assigned to a candidate navigation point that is farther from the robot.
